(19) United States
(12) Patent Application Publication
(10) Pub. No.: US 2025/0033572 A1
(43) Pub. Date: Jan. 30, 2025

(54) INTERLOCKING ANGLED ANTI-TIPPING ADJUSTABLE/TELESCOPING RODS FOR UPRIGHT BICYCLE TRANSPORT IN THE BED OF A PICK-UP TRUCK

(71) Applicant: Tyler Buron, Agoura Hills, CA (US)

(72) Inventor: Tyler Buron, Agoura Hills, CA (US)

(21) Appl. No.: 18/521,534

(22) Filed: Nov. 28, 2023

Related U.S. Application Data
(63) Continuation-in-part of application No. 18/226,640, filed on Jul. 26, 2023, now abandoned.

(51) Int. Cl. B60R 9/10

(52) U.S. Cl. CPC B60R 9/10

(57) ABSTRACT

A system for mounting a bicycle in an upright position in a truck bed is disclosed, including a first mounting component, a second mounting component and a third mounting component, each comprised of an inner member and an outer member. A padlock connects each of the inner members and the outer members to retain the telescoping inner and outer members at a fixed length. The first mounting component, the second mounting component, and the third mounting component are attached to the bed of a truck and arranged in a trigonal geometric configured to retain a bicycle in an upright configuration.

### CROSS-REFERENCE TO RELATED APPLICATIONS

The present application is a Continuation-In-Part and claims priority to U.S. Non-Provisional application Ser. No. 18/226,640 filed Jul. 26, 2023, titled “INTERLOCKING ANGLED ANTI-TIPPING ADJUSTABLE/TELESCOPING RODS FOR UPRIGHT BICYCLE TRANSPORT IN THE BED OF A PICK-UP TRUCK” which is hereby incorporated by reference in its entirety.

### TECHNICAL FIELD

The embodiments disclosed herein generally relate the field of bicycle transportation and more specifically to transporting bicycles in an upright position in the bed of a pickup truck though trigonal geometry.

### BACKGROUND

It is common for cyclists to transport bicycles using a vehicle. In some cases, the bicycles may be transported using a bike rack which attaches to the hitch mount of the vehicle or using another structural component vehicle (e.g., tailgate mounting pads, and cargo roof bike racks). If the user owns a pickup truck, they may choose to transport the bicycle in the bed of the pickup truck. While some cyclists choose to simply place the bicycles inside the bed of the truck, this can result in damage or loss of the bicycle during transit.

### SUMMARY OF THE INVENTION

This summary is provided to introduce a variety of concepts in a simplified form that is further disclosed in the detailed description of the embodiments. This summary is not intended for determining the scope of the claimed subject matter.

A system for mounting a bicycle in an upright position in a truck bed is disclosed, including a first mounting component, a second mounting component and a third mounting component, each comprised of an inner member and an outer member. A padlock connects each of the inner members and the outer members to retain the telescoping inner and outer members at a fixed length. The first mounting component, the second mounting component, and the third mounting component are attached to the bed of a truck and arranged in a trigonal geometric configured to retain a bicycle in an upright configuration.

Interlocking of the telescoping mounting components secures the bicycle in position in the truck bed. The interlocking prevents rolling out of the truck bed in any size truck bed. Other “upright” transportation methods in the bed of a pickup truck require taking off wheels as well as draping over the tailgate with the front wheel exposed (tailgate pads). These measures are time consuming and possibly damaging to the vehicle transporting the bicycles. Dents and scrapes are common from the use of tailgate pads, and it can be dangerous to take wheels off and on at will for transport. It is essential to have the least amount of contact with the surface of the transport vehicle as possible thus making the bed of the truck the most desirable place of transport.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the bicycle mounting system securing a bicycle upright in a truck bed using principles of trigonal geometry, according to some embodiments;

FIG. 2a illustrates a top plan view of the outer member of the bicycle mounting system, according to some embodiments;

FIG. 2b illustrates a side elevation view of the outer member of the bicycle mounting system, according to some embodiments;

FIG. 2c illustrates a first end elevation view of the outer member of the bicycle mounting system, according to some embodiments;

FIG. 2d illustrates a second end elevation view of the outer member of the bicycle mounting system, according to some embodiments;

FIG. 3a illustrates a top plan view of the inner member of the bicycle mounting system, according to some embodiments;

FIG. 3b illustrates a side elevation view of the inner member of the bicycle mounting system, according to some embodiments;

FIG. 3c illustrates a first end elevation view of the inner member of the bicycle mounting system, according to some embodiments;

FIG. 3d illustrates a second end elevation view of the outer member of the bicycle mounting system, according to some embodiments;

FIG. 4a illustrates an assembled mounting system at maximum length with attachment points oriented 90° in relation to each other, according to some embodiments;

FIG. 4b illustrates an assembled mounting system at minimum length with attachment points oriented 90° in relation to each other, according to some embodiments;

FIG. 5a illustrates a top plan view of the outer mounting member with internal detail (broken lines), according to some embodiments;

FIG. 5b illustrates a side elevation view of the outer mounting member with internal detail (broken lines), according to some embodiments;

FIG. 5c illustrates a side elevation view of the assembly end of the outer mounting member with internal detail (broken lines), according to some embodiments;

FIG. 5d side elevation view of the attachment end of the outer mounting member with internal detail (broken lines), according to some embodiments;

FIG. 6a illustrates a top plan view of the inner mounting member with internal detail (broken lines), according to some embodiments;

FIG. 6b illustrates a side elevation view of the inner mounting member with internal detail (broken lines), according to some embodiments;

FIG. 6c illustrates a side elevation view of the attachment end of the inner mounting member attachment with internal detail (broken lines), according to some embodiments;

FIG. 6d illustrates an end view of the inner mounting member assembly with internal detail (broken lines), according to some embodiments;

FIG. 7 illustrates a cutaway view depicting the alignment (‘set’) holes in assembled mounting member and how, through padlock or other linking item, it attaches to other mounting members to secure rigid trigonal geometry, according to some embodiments;

FIG. 8 illustrates the outer mounting member in isometric projection, according to some embodiments;

FIG. 9 illustrates the inner mounting member in an isometric projection, according to some embodiments;

FIG. 10a 12 illustrates the mounting system at a maximum length, in isometric projection, with attachment points oriented 90° in relation to each other, according to some embodiments;

FIG. 10b illustrates the assembled mounting system at a minimum length, in isometric projection, with attachment points oriented 90° in relation to each other, according to some embodiments;

FIG. 11 illustrates the mounting system being secured to the saddle rail of a bicycle by means if a padlock with adjustable shackle, according to some embodiments; and

FIG. 12 illustrates the mounting system being secured to the anchor point of a truck-bed by means of a padlock, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a bicycle mounting system to allow a user to mount and retain a bicycle in an upright position in the bed of a pickup truck. The mounting system prevents the bicycle from tipping over as well as being removed from the bed of the pickup truck during transit or while parked. Trigonal geometry principles are utilized to retain the bike in the upright position while the vehicle is stationary and while the vehicle is in motion. This aid in reducing damage to the bicycle while it is retained in the bed of the pickup truck.

In some embodiments, the mounting system may be utilized as an anti-theft device or as a theft deterrent. This may be especially important as the bicycle is standing upright and visible by others.

During use, the user utilizes trigonal geometry in symmetry to create securement of his/her cargo. The mounting system is adjustable/telescoping via the sliding engagement of the inner and outer members and can be set to user's specific required lengths. Lengths are determined by the size and shape of the truck bed, the size and shape of the bicycle, as well as the preferred mounting position of the bicycle.

The mounting system solves a problem where the barrier created by tension straps and similar products exist. Damage to the bicycle while using the mounting system described herein is virtually impossible as the system components are attached to the bottom of the bike seat (“saddle”). The only free-play in the method of application is the slide on the undercarriage of the bike seat so it is inherently expressed that the use of shorter, rather than longer locks are utilized for securement. The less potential for the components to slide up and down on the bottom of the bike seat, the more secure the mounting of the bike.

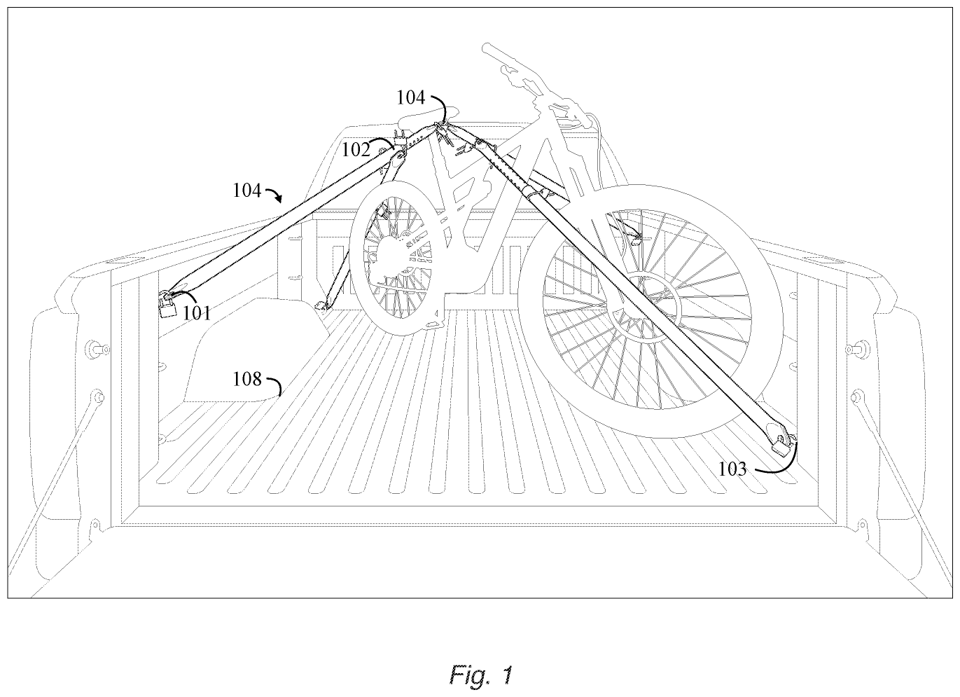

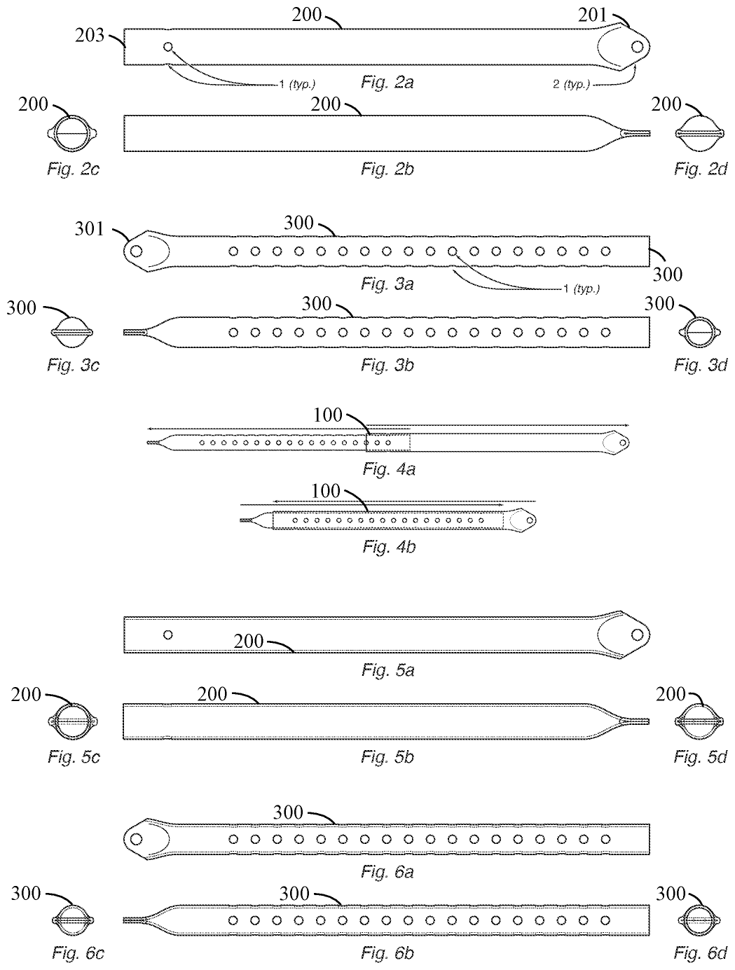

FIG. 1 illustrates a perspective view of the bicycle mounting system 100 securing a bicycle 104 upright in a truck bed 108 using principles of trigonal geometry. The bicycle mounting system 100 has an attachment point 102 and anchor point 103 to secure the bicycle 104 in a suitable upright position in the truck bed 108. The bicycle mounting system 100 is comprised of a first mounting component 110, a second mounting component 120, and a third mounting component 130. Each of the first mounting component 110, the second mounting component 120, and the third mounting component 130 include an inner member and an outer member described below and illustrated in FIGS. 2a-6b. The first mounting component 110, second mounting component 120, and third mounting component 130 are arranged and connected as shown in FIG. 1 using trigonal geometry principles.

Existing truck anchors or hooks are rounded off in nature. As they are “rounded off”, the mounting member end is flattened out and cut at a 60 degree angle. This angle is to ensure the flat end does not catch on the truck hooks and create unwanted/undesirable tension that could break/snap them. The four corners of the vehicle bed are utilized for the earlier noted Trigonal symmetry users ultimately want to achieve.

In this embodiment, the inventive manner of the mounting system is illustrated through Geometric and telescoping modality. Adjustable/telescoping rods (i.e., the first mounting component 110, the second mounting component 120, and the third mounting component 130) are secured to the bed of a transport vehicle that attach to one another for desired symmetry to prevent tipping and rolling of the bicycle 104.

FIG. 2a-2d illustrate the outer member 200 of the bicycle mounting system. The outer member includes a first end 201 and a second end 203. FIG. 3a-3d illustrate the inner member 300 of the bicycle mounting system including a first end 301 and a second end 303. The inner member includes a plurality of through holes which align with a single through hole positioned on the outer member 200 and permit the padlock to extend therethrough.

FIG. 4a-4b illustrate an assembled mounting system 100 at maximum length (see FIG. 4a) and minimum length (see FIG. 4b) with attachment points oriented 90° in relation to each other. FIG. 5a-5d illustrate the outer mounting member 200 with internal detail (broken lines) to illustrate the telescopic interaction between the outer member 200 and the inner member 300. Similarly, FIG. 6a-6d illustrates the inner mounting member 300 with internal detail (broken lines).

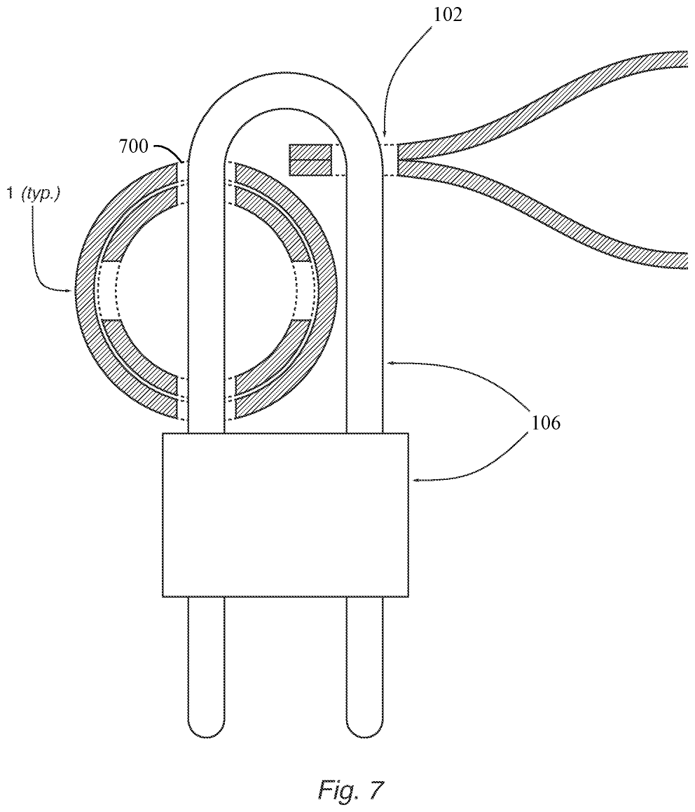

FIG. 7 illustrates the alignment (‘set’) holes 700 (in assembled mounting component and how, through padlock 107 or other linking item, it attaches to other mounting components to secure rigid trigonal geometry.

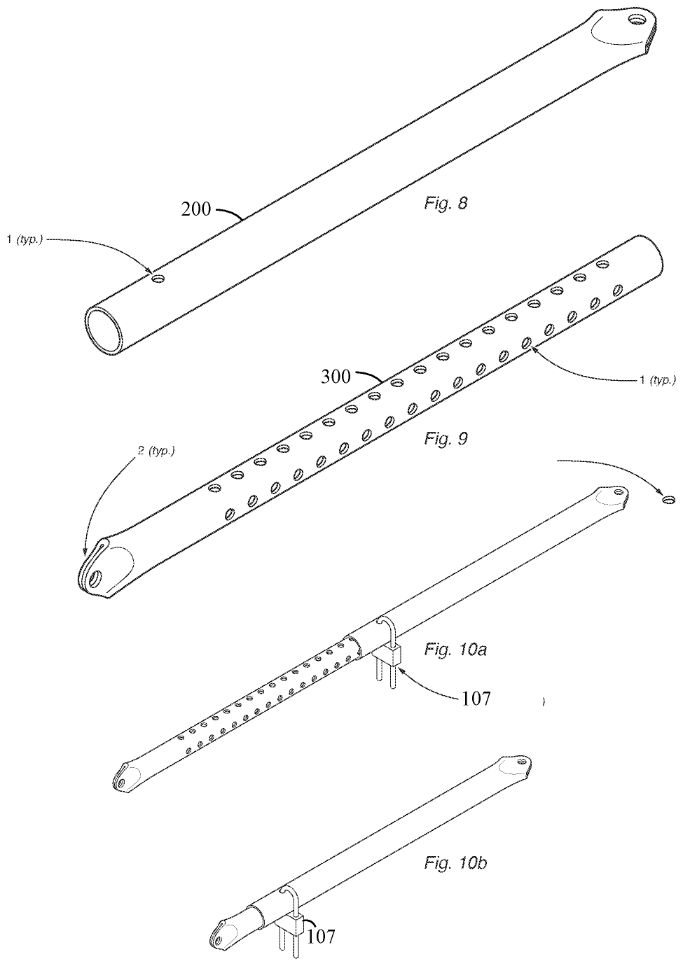

FIG. 8 illustrates the outer mounting member 200 in isometric projection and FIG. 9 illustrates the inner mounting member 300 in an isometric projection.

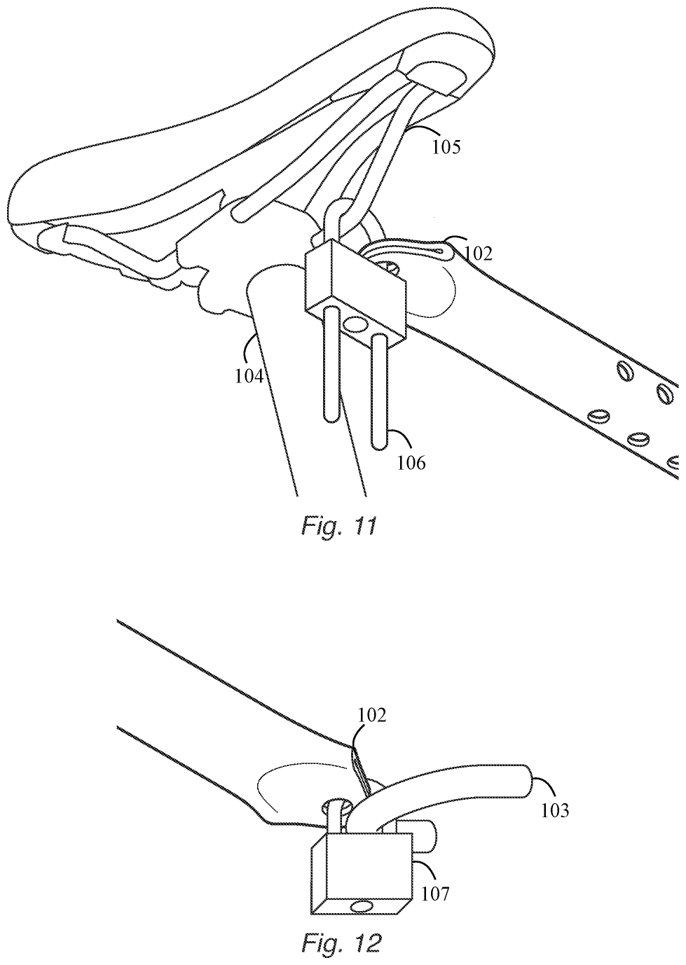

FIG. 10a-10b illustrates the mounting system at a maximum length (see FIG. 10a) and at a minimum length (see FIG. 10b), in an isometric projection, with attachment points oriented 90° in relation to each other. The padlock 107 is positioned through an aperture 700 aligned through the inner member 300 and outer member 200. This maintains the length of the mounting component during use to ensure the bicycle is secured in position.

FIG. 11 illustrates the mounting system being secured to the saddle rail 105 of a bicycle 104 by means if a padlock with an adjustable padlock 106. FIG. 12 illustrates the mounting system 100 being secured to the anchor point 103 of a truck bed 108 by means of a padlock 107, according to some embodiments. One skilled in the arts will readily understand that the padlock 107 can be configured as any locking device known in the arts including combination locks, chain locks, and other common locking mechanisms used for bicycles or general locking of items.

In this embodiment, the inventive manner of Cycle Stix is illustrated through Geometric and telescoping modality. Adjustable/telescoping rods secured to the bed of a transport vehicle that attach to one another for desired symmetry to prevent tipping and rolling of bicycles. Through the provided photos (1-16) and line art renders (FIG. 1-12), Cycle Stix is simple to understand and use for most consumers. This embodiment yields application for bicycles of any size as long as there is a means of attachment in the illustrated way (FIG. 11).

In some embodiments, the apertures, or “set points” along the inner members that allow for adjustments to optimum length to fit any type or bicycle as long as it has a seat (“saddle”).

In some embodiments, the set point secures both the mounting members on either left or right side to one another to create the notes trigonal symmetry. This symmetry prevents the mounting member (when attached to the bicycle) from shifting preventing the bike from moving at all (forwards, backwards, tipping or side-to-side).

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for mounting a bicycle in an upright position in a truck bed, the system comprising:
a first mounting component, a second mounting component and a third mounting component, each of the first mounting component, the second mounting component, and the third mounting component comprised of an inner member and an outer member;
a padlock to rigidly connect each of the inner members and the outer members,
wherein first mounting component, the second mounting component, and the third mounting component are attached to the bed of a truck and arranged in a trigonal geometric configured to retain a bicycle in an upright configuration.

2. The bicycle mounting system of claim 1, further comprising a plurality of apertures positioned on the inner member.

3. The bicycle mounting system of claim 2, further comprising an aperture on the outer member to align with the plurality of apertures on the inner member.

4. The bicycle mounting system of claim 3, wherein the padlock extends through the aligned apertures on the inner member and the outer member to retain the mounting component at a fixed length.

5. The bicycle mounting system of claim 1, wherein each of the outer members include a first end to attach to the bed of the truck.

6. The bicycle mounting system of claim 1, wherein each of the inner members include a first end to interlock and attach to the bicycle.

7. The bicycle mounting system of claim 1, wherein the padlock is an adjustable length padlock.

8. A system for mounting a bicycle in an upright position in a truck bed, the system comprising:
a first mounting component, a second mounting component and a third mounting component, each of the first mounting component, the second mounting component, and the third mounting component comprised of an inner member and an outer member;
a plurality of apertures positioned on each of the first mounting component, the second mounting component and the third mounting component to receive a padlock and retain them in at a fixed length, the padlock to rigidly connect each of the inner members and the outer members,
wherein first mounting component, the second mounting component, and the third mounting component are attached to the bed of a truck and arranged in a trigonal geometric configured to retain a bicycle in an upright configuration.

9. The bicycle mounting system of claim 8, further comprising a plurality of apertures positioned on the inner member.

10. The bicycle mounting system of claim 9, further comprising an aperture on the outer member to align with the plurality of apertures on the inner member.

11. The bicycle mounting system of claim 10, wherein the padlock extends through the aligned apertures on the inner member and the outer member to retain the mounting component at a fixed length.

12. The bicycle mounting system of claim 11, wherein each of the outer members include a first end to attach to the bed of the truck.

13. The bicycle mounting system of claim 12, wherein each of the inner members include a first end to interlock and attach to the bicycle.

14. The bicycle mounting system of claim 13, wherein the padlock is an adjustable length padlock.

15. The bicycle mounting system of claim 14, wherein the first end of the inner member is rounded at a 60° angle.

16. The bicycle mounting system of claim 15, wherein the first end of the outer member is rounded at a 60° angle.

17. The bicycle mounting system of claim 16, wherein the bicycle mount prevents the bicycle from rolling in the bed of the truck.

18. The bicycle mounting system of claim 17, wherein the bicycle mount prevents the bicycle from being removed from the bed of the truck via the padlock.
